(19) United States
(12) Patent Application Publication
(10) Pub. No.: US 2010/0050440 A1
(43) Pub. Date: Mar. 4, 2010

(54) UTENSIL AND METHOD FOR COLLECTING AND POURING POWDERS AND FLUIDS

(76) Inventor: David BEN NATAN, Petach Tikva (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/203,945

(22) Filed: Sep. 4, 2008

(51) Int. Cl. A47J 43/28; B65D 25/28; G01F 19/00

(52) U.S. Cl. 30/141; 220/756; 220/771; 73/426

(57) ABSTRACT

A utensil and method for collecting measuring and pouring powders and fluids, the utensil is made as a single unit including a collection container, holding handle containing a tube which has one opening in the wall of the collection container and a discharge opening at the end of the handle. The method includes collecting the substance into the collection container, moving the utensil to the place of dispersal, and pouring the collected substance through the discharge opening.

### FIELD AND BACKGROUND OF THE INVENTION

The present invention relates to a utensil and method for collecting and pouring powders and fluids and in particular to a utensil and method for precise collecting and pouring of powders and fluids at volumes of single cubic centimeters.

Utensils for collecting and pouring powders and fluids have been used from time immemorial.

Modem times have presented several new solutions, one example of which is a domestic utensil serving both as a scoop and a funnel is described in London's Patent No. 612,851, of Terence John Bhown, and John Gordon Ross Lyon, both British subjects.

FIG. 1 of the prior art illustrates an article for use by the housewife in handling powdered substances such as salt, pepper and so on. FIG. 1 is a perspective view of the prior art article. The article 500 has a body portion in the form of a very short hollow cylinder 51, about 1 inch diameter with approximately semi-cylindrical extension 52 about 1 inch long and beveled at about 45° at its open end so as to form the body of the scoop. The short cylindrical portion tapers conically to the other direction at an angle of about 45° to a smaller diameter so as to form the body 53 of the funnel. The small end of this tapered portion has a tubular extension 54 serving both as the handle of the scoop and the spout of the funnel. The end of the handle portion can be beveled as in 55 to facilitate pouring from it.

At present there is a need for a utensil with improved qualities relative to the prior art which will enable clean and precise collection of powder or fluid, particularly from relatively narrow and deep containers, and conveniently and precisely pouring it.

### SUMMARY OF THE INVENTION

According to the present invention there is provided a utensil for collecting, measuring, and pouring powders and fluids, the utensil including: (a) an arched holding handle having internal tube, first end and second end; (b) a collection container having opening disposed at the first end of the utensil; and (c) a discharge opening disposed at the second end of the utensil; wherein the utensil is substantially so formed, as the collection container and the internal tube constitute one space, enabling pouring powders and fluids to be collected through the collection container opening, to flow through the internal tube, and to be dispersed through the discharge opening.

According to still further features in the described preferred embodiments of the utensil, the space having an external envelope of a form of one continuous surface, including no point of discontinuity, enabling laminar streaming.

According to still further features in tie described preferred embodiments of the utensil, the arched holding handle, and the collection container are formed as a one piece unit, and wherein the utensil has a virtual symmetry plane.

According to still further features in tie described preferred embodiments tie utensil has an upper external surface and wherein the opening of the collection container is a hole in the upper external surface.

According to still further features in the described preferred embodiments of the utensil, discharge opening is substantially disposed on a discharge opening plane which forms an angle Beta with a first tangent to the upper external surface on tie virtual symmetry plane at a point where the discharge opening plan intersects with the upper external surface, and wherein the angle Beta is at least 30 degrees and at most 80 degrees.

According to still further features in the described preferred embodiments of the utensil, the upper external surface has a first tangent on the virtual symmetry plane at a point where the discharge opening plane intersects with the upper external surface and a second tangent on the virtual symmetry plane at a point where the upper external surface is cut off by the opening of the collection container, wherein the first tangent and the second tangent form an angle Alfa, wherein the angle Alfa is at least 5 degrees and at most 40 degrees.

According to still further features in the described preferred embodiments, the utensil finer including: (d) measure marks disposed at the collection container; and (e) a front lip disposed in the collection container; and wherein at the utensil is at least partially transparent

According to still her features in the described preferred embodiments of the utensil, the internal tube forms two curves at its intersection points with the virtual symmetry plane, having a local distance between the two curves, wherein the local distance decreases progressing towards the discharge opening, and wherein the local distance towards the discharge opening is at least 0.8 of largest the local distance.

According to still further features in the described preferred embodiments the utensil further including; (d) at least two groups of measurement marks groups disposed in the collection container; and (e) a front lip disposed in the collection container; and wherein at the utensil is at least partially transparent.

According to the present invention there is provided a method of collecting, from an initial storage container, measuring, and pouring powders and fluids, including the steps of: (a) providing a utensil for collecting, measuring, and pouring powders and fluids, the utensil including: (i) an arched holding handle having internal tube, first end and second end; (ii) a collection container having opening disposed at the first end of the utensil; and (iii) a discharge opening disposed at the second end of the utensil; wherein the utensil is substantially so formed, as the collection container and the internal tube constitute one space, enabling pouring powders and fluids to be collected through the collection container opening, to flow through the internal tube, and to be dispersed through the discharge opening; (b) holding the utensil and collecting material into the collection container from the initial storage container.

According to still further features in the described method, the method further including the step of: (c) tilting the utensil so that at least part of the material enters into the internal tube; and then (d) collecting an additional amount of material into the collection container from the initial storage container.

According to still further features in the described method, the method further including the step of: (c) moving the utensil with the material inside the utensil; and (d) tipping the utensil.

According to still further features in the described method, the material is poured into a second storage container.

According to still hither features in the described method, the pouring of the material has a flow rate, and wherein the flow rate is controlled according to tipping of the utensil.

According to still further features in the described method, the material is dispersed by shaking the utensil.

According to still further features in the described method, the material is powder.

According to still further features in the described method, n the material is fluid.

### BRIEF DESCRIPTION OF TM DRAWINGS

The invention is herein described, by way of example only, with reference to the accompanying drawings, wherein:

FIG. 1 is a perspective view of a prior art article for handling powdered substances.

FIG. 2 is a perspective view of a utensil for collecting and pouring powders and fluids according to the present invention.

FIG. 3 is another schematic illustration of a perspective view of a utensil for collecting and pouring powders and fluids according to the present invention.

FIG. 4 is a schematic illustration of a top view of a utensil for collecting and pouring powders and fluids according to the present invention.

FIG. 5 is a schematic illustration of a side view of a section of a utensil for collecting and pouring powders and fluids according to the present invention.

FIG. 6 is a schematic illustration of a top view of a utensil for collecting and pouring powders and fluids according to the present invention.

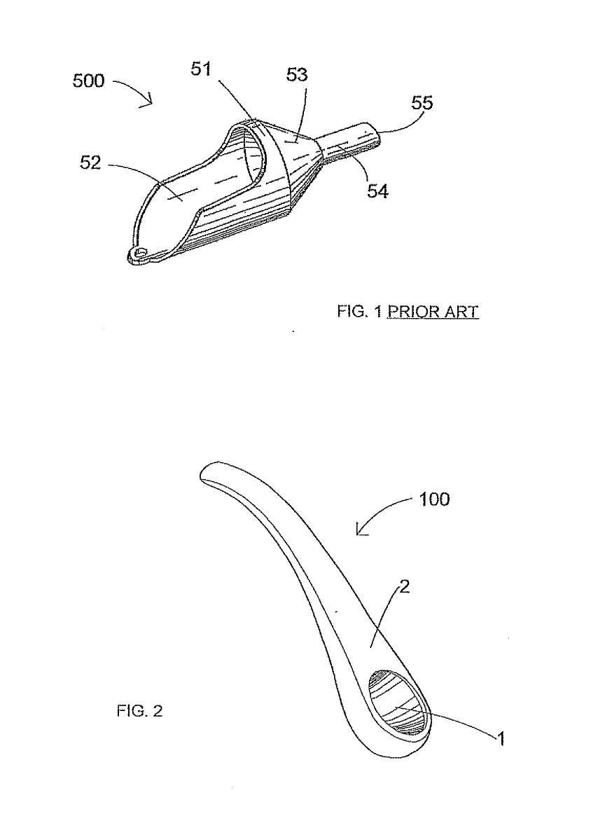

### DESCRIPTION OF THE PREFERRED EMBODIMENTS

The principles and operation of a utensil and method for collecting and pouring powders and fluids according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

The following list is a legend of the numbering of the application illustrations:

100 utensil for collecting, measuring, and pouring powders and fluids

1 collection container with entry opening

2 holding handle with internal tube

3 discharge opening

4 font lip

5 curve of upper side of section of internal tube

6 curve of lower side of section of internal tube

7 curve of upper side of section of upper external surface

8 internal tube

9 measurement markings

D local distance between curves of section of internal tube

Alfa utensil inclination angle

Beta discharge opening inclination angle

10 first storage container

11 second storage container

20 powder/fluid

30 hand

500 prior art article

51 short hollow cylinder

52 semi-cylindrical extension

53 body

54 tubular extension

55 handle

D local distance between curves of section of internal tube

As used herein the specification and in the claims section that follows, the term “powder” and the like refer to a substantially solid material including grains, with the typical size of a grain similar to the standard typical size of a grain of sugar used for sweetening tea and coffee in domestic use or a smaller typical size.

The utensil and method for collecting and pouring powders and fluids according to the present invention are based on a principle including clean and precise collection of powder or fluid on one side of the utensil, transferring the material collected through a tube, and conveniently and precisely pouring it out of the other side which is designated for pouring or dripping.

The powder can be powders such as, but not exclusively, types of sugar, coffee, and spices, and the fluids can be fluids such as, but not exclusively, water, sauces, liquid condiments, and sweeteners.

The principle of the invention can be applied in many fields and can be used in a variety of environments and with a wide age span.

Referring now to the drawings, FIG. 2 is a perspective view of utensil for collecting and pouring powders and fluids 100 according to the present invention.

The external design of utensil 100 appears as a unified cylinder, elongated and curved, reminiscent of the form of a gourd, starting at one end with rounded contours of a certain width and tapering towards its other end, which is trimmed. The lateral sections of the cylinder can have many shapes, ranging from simple circular or elliptical shapes of varying sizes, through shapes that vary with the progression from one end to the other, to sections of other various complex shapes. Usually, unless a specific need requires another form, the cylinder will be symmetrical relative to a symmetry plane.

The unique form of utensil 100, with an opening for collection of liquids and powders open at an upper external surface on its wide end, the front, enables collection of powders and liquids from containers of a narrow and deep form or through relatively narrow openings, followed by carrying them and pouring them into another container, or dispersing them over a defined surface.

This illustration shows that holding handle 2 can have an arched shape. The illustration also clearly shows collection container 1 with an entry opening.

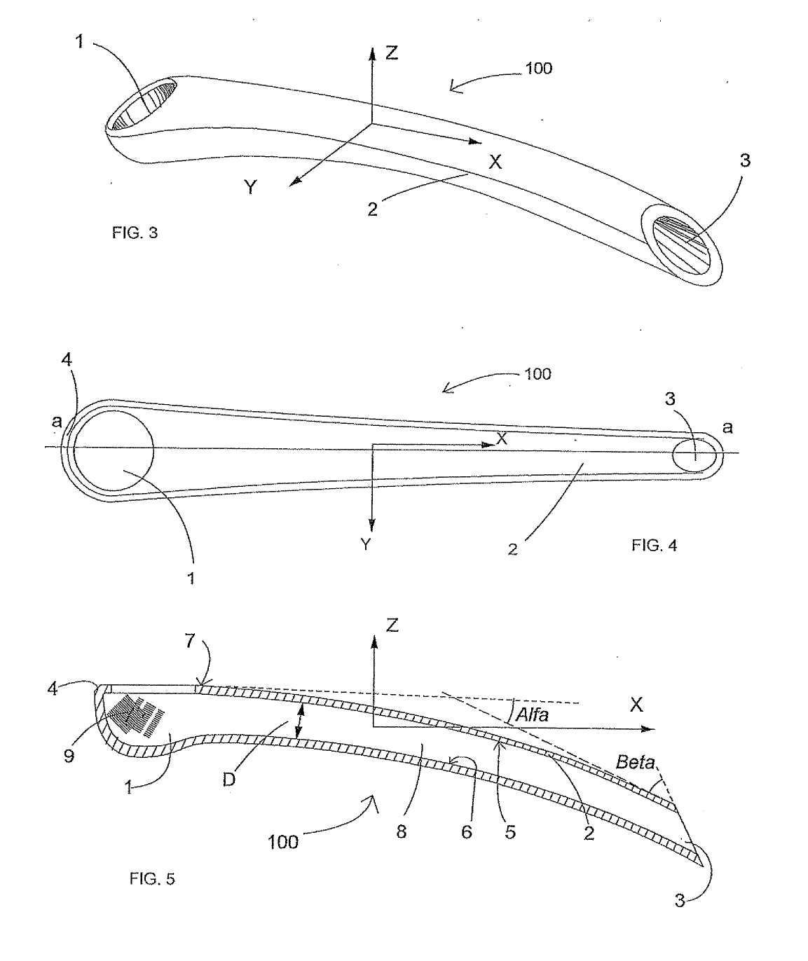

FIG. 3 is another schematic illustration of a perspective view of utensil for collecting and pouring powders and fluids 100 according to the present invention. This illustration shows discharge opening 3. Utensil 100 is built as a single unit, to which a virtual Cartesian coordinate system is fixed, two axes of which, X axis and Y axis, define a plane which is horizontal plane, while utensil 100 is disposed such that the Z axis, the third axis of the Cartesian coordinate system, is inverse to the direction of the local gravitational force of the earth, defining the side of the utensil 100 referred to as the upper side.

The two axes, X axis and Z axis, define a plane which can serve as the symmetry plane of the utensil 100.

Precise collection of powder or liquid by means of utensil 100 can be done for a fixed defined volume according to the volume of container 1 or for smaller volumes if measurement markings 9 or any other suitable means of indication are disposed on the inner wall of container 1 or even its outer wall, if the container is completely or partially made of translucent material.

Measurement markings 9 can be made at different angles, with regard to the coordinates. The user can thus choose an inclination angle, with regard to the horizon, of utensil 100 which is adapted to the most convenient way to hold utensil 100. Measurement can be done by means of groups of suitable measurement markings 9. The illustration shows two groups of measurement markings 9 each at a different angle with regard to coordinate X. The markings of each group can be made differently, for example in different colors.

In order to enable collection of a precise fixed volume of powder or fluid that is other than the volume of a full container, one internal marking can be made in container 1. This marking can be a groove, paint, or any other suitable marking, and can be continuous or fragmented on the entire circumference of container 1 or part of it. Particularly when collecting fluids, high precision can be achieved when, during measurement, utensil 100 is positioned in a spatial orientation such that said marking is perpendicular to the local gravitational force. This is easily done by aligning the plane of the marking with the plane of the surface of the fluid.

FIG. 4 is a schematic illustration of a top view of a utensil for collecting and pouring powders and fluids 100 according to the present invention. Even though utensil 100 is a single unified body, it is composed of three main parts: collection container 1 with a top opening that can be disposed an a plane approximately parallel to X-Y plane, collection container 1 is attached to holding handle 2 in which a tube is disposed, one opening of which is disposed in a suitable place on the wall of container 1, with a discharge opening not shown in the illustration disposed on the other end of the holding handle.

FIG. 5 is a schematic illustration of a side view of a section of a utensil for collecting and pouring powders and fluids 100 according to the present invention. The section is along line, a-a shown in FIG. 4. This section illustrates the internal tube 8 connecting the collection container 1 with the discharge opening 3 enabling the passage of powders and fluids. The illustration shows the upper curve S and lower curve 6 formed by the section plane in the internal tube 8 and the distance between them at a certain point marked as D.

According to a preferred embodiment of the present invention, in order to enable smooth and efficient flow within the internal tube 8, these section lines are continuous and without points of discontinuity, including their points of connection to the collection container 1, and can be expressed as mathematical functions. This continuity without any points of discontinuity is maintained throughout the entire surface encasing the space through which the flow occurs.

As used herein the specification and in the claims section that follows, the term “continuous” and the like refer to a substantially conventional definition of a mathematical function ƒ(x) at a point x₀, and likewise a point of discontinuity is a point at which a fraction is not continuous.

An additional controlling influence, also increasing the velocity granted to the flow within the internal tube 8, is achieved by means of a gradual decrease in distance D progressing towards the discharge opening 3.

The lateral section of the internal tube 8 can have a fixed shape which only changes in size progressing from the collection container 1, such as an ellipse with a fixed radii ratio, but can also be a varying form, such as an ellipse with a varying radii ratio. At the point where internal tube 8 has a circular cross section, its circumference is D.

As shown in the illustration, holding handle 2 has a curved form, with a varying curve on the section plane.

The utensil for collecting and pouring powders and fluids 100 has an upper external surface which also includes the upper external surface of the holding handle 2. When this upper external surface is crossed by virtual plane X-Z, which can serve as the symmetry plane for utensil 100, a curved line is formed, being the curve of the upper external side of the section of the upper external surface 7. Seeing as holding handle 2 is curved, the tangents to this line at both of its ends form angle Alfa between themselves. This angle will be referred to as the inclination angle of the utensil in the present patent application.

Likewise, we will refer to the angle between the tangent on the end of discharge opening 3 and the plane formed by discharge opening 3; as the discharge opening inclination angle Beta.

The entry opening of the collection container is an open hole in the upper external surface. When collecting material into the collection container 1, some of it enters the curvature of the holding handle 2, which enables the collection of material without unwanted spilling of the material though the discharge opening 3. This curvature is essential in order to enable slow pouring at a well-controlled rate. Furthermore, the curvature of the discharge opening 3 is significant for convenience of use and holding, seeing as its curved shape has a clear advantage over a direct tube which is not well adapted to the arched form of the human hand. This convenience enables good control and applying delicate motion.

Selection of the shapes and dimensions of the various parts of the utensil for collecting and pouring powders and fluids 100 can be reached by trial and error, and can be adapted for collection from containers of specific shapes and dimensions, for transferring material to containers of specific shapes and dimensions, at relative locations and specific distances between containers, as well as to various sizes of users.

Furthermore, the illustration shows front lip 4 of the collection container 1. This lip helps prevent the loss of material after collection. Front lip 4 can be designed with a slight inclination upwards, forming a wider and more efficient lip to prevent spilling of powder or liquid during use, namely making the opening smaller relative to the wider section area of the collection container This inclination enables the return of material from the walls inward, by-deflecting material that is sprayed outwards.

The illustration also shows that the end of the holding handle 2 with the internal tube 8 is diagonally crossed by section plane. This section forms a discharge opening 3 with an area larger than that of the section area perpendicular to the flow.

The wide diagonals opening enables wider dispersal of the flowing material when desired, by means of shaking. Without shaking, the pouring is free and precise.

An additional advantage of this form is achieved when cleaning the discharge opening 3. Seeing as the opening is relatively wide, it is easy to clean, and dirt is always accumulated outwards on the tip of the pouring lip.

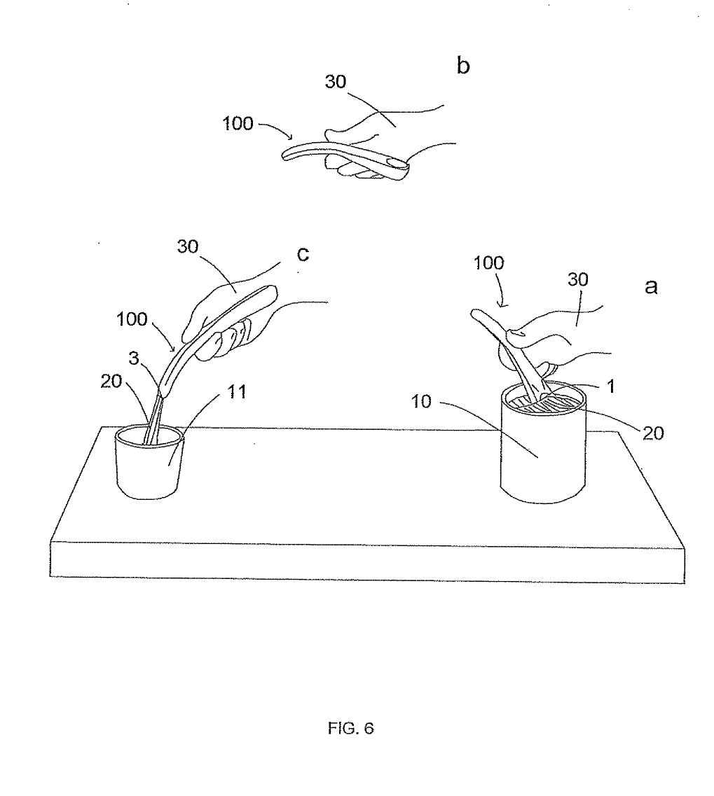

FIG. 6 is a schematic illustration of three separate steps: a, b, and c, which demonstrate the method of use of the utensil for collecting and pouring powders and fluids 100 according to the present invention.

In step a, the user holds the utensil 100 in his hand 30 and collects powder or fluid 20 into the container 1, from the initial storage container 10.

In step b, the user moves utensil 100 with the collected substance inside the container.

In step c, the user tips utensil 100 with his hand 30, so that the powder or fluid 20 is poured into the second storage container 11. According to the degree of tipping, the rate of the flow of powder or fluid 20 is determined, namely, strong and fast flow can be achieved when there is no need for controlled discharge of powder or fluid 20 from utensil 100, as well as slow flow when control is required, such as in the case that a small amount of powdered spice needs to be dispersed over a relatively large area.

The utensil and method for collecting and pouring powders and fluids according to the present invention has many advantages, some of which are:

No spilling or dripping of the powder or fluid on the way from the first container to the second container.

Powders and fluids can be taken from containers placed on high shelves or inaccessible locations without seeing their contents.

Powders or fluids can be taken from deep containers without tilting them or holding them by hand.

Salt, sugar, or dressing can be dispersed on salads and foods in a uniform manner, with slow dripping.

The utensil also has clear advantages in fostering fine motor skills and spatial perception in children.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A utensil for collecting, measuring, and pouring powders and fluids, the utensil comprising:
(a) an arched holding handle having internal tube, first end and second end;
(b) a collection container having opening disposed at said first end of said utensil; and
(c) a discharge opening disposed at said second end of said utensil;
wherein said utensil is substantially so formed, as said collection container and said internal tube constitute one space, enabling pouring powders and fluids to be collected through said collection container opening, to flow through said internal tube, and to be dispersed through said discharge opening.

2. The utensil according to claim 1, wherein said space having an external envelope of a form of one continuous surface, including no point of discontinuity, enabling laminar streaming.

3. The utensil according to claim 2, wherein said arched holding handle, and said collection container are formed as a one piece unit, and wherein said utensil has a virtual symmetry plane.

4. The utensil according to claim 3, wherein said utensil has an upper external surface and wherein said opening of said collection container is a hole in said upper external surface.

5. The utensil according to claim 4, wherein said discharge opening is substantially disposed on a discharge opening plane which forms an angle Beta with a first tangent to said upper external surface on said virtual symmetry plane at a point where said discharge opening plan intersects with said upper external surface, and wherein said angle Beta is at least 30 degrees and at most 80 degrees.

6. The utensil according to claim 4, wherein said upper external surface has a first tangent on said virtual symmetry plane at a point where said discharge opening plane intersects with said upper external surface and a second tangent on said virtual symmetry plane at a point where said upper external surface is cut off by said opening of said collection container, wherein said first tangent and said second tangent form an angle Alfa, wherein said angle Alfa is at least 5 degrees and at most 40 degrees.

7. The utensil according to claim 4, further comprising:
(d) measure marks disposed at said collection container; and
(e) a front lip disposed in said collection container; and wherein at said utensil is at least partially transparent.

8. The utensil according to claim 4, wherein said internal tube forms two curves at its intersection points with said virtual symmetry plane, having a local distance between said two curves, wherein said local distance decreases progressing towards said discharge opening, and wherein said local distance towards said discharge opening is at least 0.8 of largest said local distance.

9. The utensil according to claim 4, further comprising:
(d) at least two groups of measurement marks groups disposed in said collection container; and
(e) a front lip disposed in said collection container; and wherein at said utensil is at least partially transparent.

10. A method of collecting, from an initial storage container, measuring, and pouring powders and fluids, comprising the steps of:
(a) providing a utensil for collecting, measuring, and pouring powders and fluids, said utensil including:
(i) an arched holding handle having internal tube, first end and second end;
(ii) a collection container having opening disposed at said first end of said utensil; and
(iii) a discharge opening disposed at said second-end of said utensil;
wherein said utensil is substantially so formed, as said collection container and said internal tube constitute one space, enabling pouring powders and fluids to be collected through said collection container opening, to flow through said internal tube, and to be dispersed through said discharge opening;
(b) holding said utensil and collecting material into said collection container from said initial storage container.

11. The method of claim 10, further comprising the step of:
(c) tilting said utensil so that at least part of said material enters into said internal tube; and then
(d) collecting an additional amount of material into said collection container from said initial storage container.

12. The method of claim 10, further comprising the steps of:
(c) moving said utensil with said material inside said utensil; and
(d) tipping said utensil.

13. The method according to claim 12, wherein said material is poured into a second storage container.

14. The method according to claim 12, wherein said the pouring of said material has a flow rate, and wherein said flow rate is controlled according to tipping of said utensil.

15. The method according to claim 12, wherein said material is dispersed by shaking said utensil.

16. The method according to claim 12, wherein said material is powder.

17. The method according to claim 12, wherein said material is fluid.
